(19) United States
(12) Patent Application Publication
(10) Pub. No.: US 2026/0164333 A1
(43) Pub. Date: Jun. 11, 2026

(54) CONDITIONAL HANDOVER EVENT IN TERRESTRIAL NETWORK

(71) Applicant: Apple Inc., Cupertino, CA (US)

(72) Inventors: Peng Cheng, Beijing (CN); Yuqin Chen, Beijing (CN); Fangli Xu, Beijing (CN); Haijing Hu, Los Gatos, CA (US)

(73) Assignee: Apple Inc., Cupertino, CA (US)

(21) Appl. No.: 18/706,370

(22) PCT Filed: May 10, 2023
(86) PCT No.: PCT/CN2023/093223

§ 371 Date: Apr. 30, 2024

(51) Int. Cl. H04W 36/36; H04W 36/08; H04W 52/02

(52) U.S. Cl. CPC H04W 36/362; H04W 36/08; H04W 52/0209

(57) ABSTRACT

Provided is a method for a user equipment (UE). The UE receives at least one conditional handover (CHO) command comprises an Ax event condition and a Tx event condition from a base station (BS). The Ax event condition includes A3, A4 or A5 event condition and the Tx event condition is a time-based trigger condition. The UE evaluates both of the Ax event condition and the Tx event condition to determine whether either the Ax event condition or the Tx event condition is met. In response to determining either the Ax event condition or the Tx event condition is met, The UE determines a triggered cell for executing a CHO.

### TECHNICAL FIELD

The present disclosure relates generally to wireless communication systems, and more specifically to timer based conditional handover (CHO) event in terrestrial network (TN).

### BACKGROUND

Wireless mobile communication technology uses various standards and protocols to transmit data between a base station and a wireless mobile device. Wireless communication system standards and protocols can include, but not limited to, the 3rd Generation Partnership Project (3GPP) long term evolution (LTE); fifth-generation (5G) 3GPP new radio (NR) standard; and technologies beyond 5G. In fifth-generation (5G) wireless radio access networks (RANs), the base station may include an RAN Node such as a 5G Node, new radio (NR) node or g Node B (gNB), which communicate with a wireless communication device, also known as user equipment (UE).

### SUMMARY

According to an aspect of the present disclosure, a method for a user equipment (UE) is provided that comprises receiving, from a base station (BS), at least one conditional handover (CHO) command that comprises an Ax event condition and a Tx event condition, wherein the Ax event condition includes A3, A4 or A5 event condition and the Tx event condition is a time-based trigger condition; evaluating both of the Ax event condition and the Tx event condition to determine whether either the Ax event condition or the Tx event condition is met; and determining, in response to determining either the Ax event condition or the Tx event condition is met, a triggered cell for executing a CHO.

According to an aspect of the present disclosure, an apparatus for a UE is provided that comprises one or more processors configured to perform operations comprising: receiving, from a base station (BS), at least one conditional handover (CHO) command that comprises an Ax event condition and a Tx event condition, wherein the Ax event condition includes A3, A4 or A5 event condition and the Tx event condition is a time-based trigger condition; evaluating both of the Ax event condition and the Tx event condition to determine whether either the Ax event condition or the Tx event condition is met; and determining, in response to determining either the Ax event condition or the Tx event condition is met, a triggered cell for executing a CHO.

According to an aspect of the present disclosure, a computer readable medium is provided that has computer programs stored thereon, which when executed by one or more processors, cause the one or more processors to perform operations comprising: receiving, from a base station (BS), at least one conditional handover (CHO) command that comprises an Ax event condition and a Tx event condition, wherein the Ax event condition includes A3, A4 or A5 event condition and the Tx event condition is a time-based trigger condition; evaluating both of the Ax event condition and the Tx event condition to determine whether either the Ax event condition or the Tx event condition is met; and determining, in response to determining either the Ax event condition or the Tx event condition is met, a triggered cell for executing a CHO.

### BRIEF DESCRIPTION OF THE DRAWINGS

Features and advantages of the disclosure will be apparent from the detailed description which follows, taken in conjunction with the accompanying drawings, which together illustrate, by way of example, features of the disclosure.

FIG. 1 is a block diagram of a system including a base station and a user equipment (UE) in accordance with some embodiments.

FIG. 2 illustrates a flowchart for an exemplary method for a UE in accordance with some embodiments.

FIG. 3 illustrates an exemplary diagram of T1 event condition in accordance with some embodiments.

FIG. 4A illustrates an exemplary diagram of T2 event condition in accordance with some embodiments.

FIG. 4B illustrates another exemplary diagram of T2 event condition in accordance with some embodiments.

FIG. 5A illustrates an exemplary diagram of T3 event condition in accordance with some embodiments.

FIG. 5B illustrates another exemplary diagram of T3 event condition in accordance with some embodiments.

FIG. 6 illustrates a flowchart for an exemplary method for a base station in accordance with some embodiments.

FIG. 7 illustrates an exemplary block diagram of an apparatus for a UE in accordance with some embodiments.

FIG. 8 illustrates an exemplary block diagram of an apparatus for a base station in accordance with some embodiments.

FIG. 9 illustrates example components of a device in accordance with some embodiments.

FIG. 10 illustrates example interfaces of baseband circuitry in accordance with some embodiments.

FIG. 11 illustrates components in accordance with some embodiments.

FIG. 12 illustrates an architecture of a wireless network in accordance with some embodiments.

### DETAILED DESCRIPTION

In the present disclosure, a “base station” can include a RAN Node such as an Evolved Universal Terrestrial Radio Access Network (E-UTRAN) Node B (also commonly denoted as evolved Node B, enhanced Node B, eNodeB, or eNB) and/or Radio Network Controller (RNC), and/or a 5G Node, new radio (NR) node or g Node B (gNB), which communicate with a wireless communication device, also known as user equipment (UE). Although some examples may be described with reference to any of E-UTRAN Node B, an eNB, an RNC and/or a gNB, such devices may be replaced with any type of base station.

In NR release 17, T1 event condition has been introduced into a conditional handover (CHO) for non-terrestrial network (NTN). In the scenario of NTN, T1 event condition must be configured together with any of CHO events A3-A5, and a CHO procedure can be executed only if one of CHO events A3-A5 is satisfied between timing T1 threshold and T2 (T1 threshold plus a duration). That is, a CHO procedure can be executed only when both Ax event condition and T1 event condition are met. For terrestrial network (TN), a timer based CHO event, intended to improve the mobility of the UE, may have attracted attentions and need to be discussed further.

In the technologies related to a conditional handover (CHO), time-based trigger condition has been introduced for NTN. Since a global navigation satellite system (GNSS) is always equipped in a NTN UE, the NTN UE can acquire accurate coordinated universal time (UTC) time via the GNSS. The NTN UE receives an Ax event condition and a T1 event condition from a base station and initiates a CHO procedure when both Ax event condition and T1 event condition are met.

However, in the scenario of TN, some UEs do not support GNSS. Such UEs (e.g., a network energy saving (NES) or an integrated access and backhaul (IAB) UE that doesn't support GNSS) may not be able to get accurate UTC to correctly evaluate whether a time-based trigger condition is met or not. Therefore, a time-based trigger condition may not be implemented in the case of TN. In addition, the CHO condition that both Ax event condition and T1 event condition are met may be too strict for an NES UE or an IAB UE. A relaxed CHO condition needs to be considered and introduced for a UE that does not support GNSS in the case of TN.

Aiming to this, it is provided by the present disclosure timer based CHO event in TN. Various aspects of the present disclosure will be described below in conjunction with the accompanying drawings.

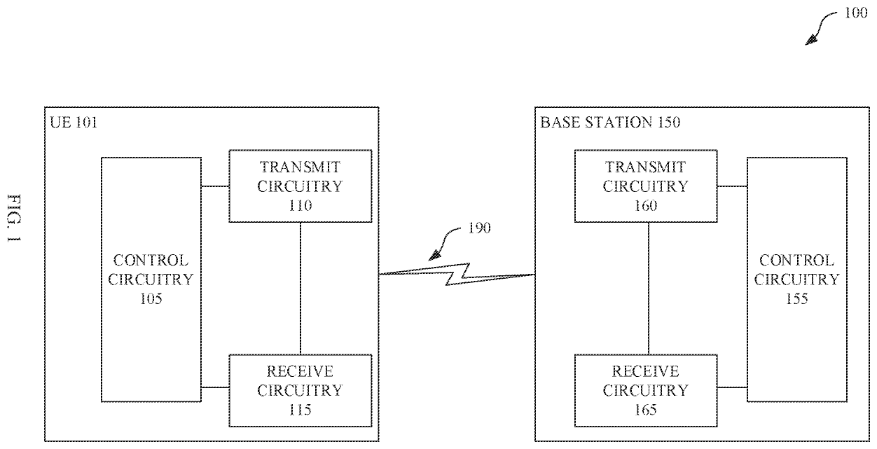

FIG. 1 is a block diagram of a system including a base station and a UE in accordance with some embodiments. FIG. 1 illustrates a wireless network 100, in accordance with some embodiments. The wireless network 100 includes a UE 101 and a base station 150 connected via an air interface 190. In some embodiments, the base station 150 may be a mobile base station, such a mobile IAB node.

The UE 101 and any other UE in the system may be, for example, laptop computers, smartphones, tablet computers, printers, machine-type devices such as smart meters or specialized devices for healthcare monitoring, remote security surveillance, an intelligent transportation system, or any other wireless devices with or without a user interface. The base station 150 provides network connectivity to a broader network (not shown) to the UE 101 via the air interface 190 in a base station service area provided by the base station 150. In some embodiments, such a broader network may be a wide area network operated by a cellular network provider, or may be the Internet. Each base station service area associated with the base station 150 is supported by antennas integrated with the base station 150. The service areas are divided into a number of sectors associated with certain antennas. Such sectors may be physically associated with fixed antennas or may be assigned to a physical area with tunable antennas or antenna settings adjustable in a beamforming process used to direct a signal to a particular sector. One embodiment of the base station 150, for example, includes three sectors each covering a 120-degree area with an array of antennas directed to each sector to provide 360-degree coverage around the base station 150.

The UE 101 includes control circuitry 105 coupled with transmit circuitry 110 and receive circuitry 115. The transmit circuitry 110 and receive circuitry 115 may each be coupled with one or more antennas. The control circuitry 105 may be adapted to perform operations associated with Machine Type Communication (MTC). In some embodiments, the control circuitry 105 of the UE 101 may perform calculations or may initiate measurements associated with the air interface 190 to determine a channel quality of the available connection to the base station 150. These calculations may be performed in conjunction with control circuitry 155 of the base station 150. The transmit circuitry 110 and receive circuitry 115 may be adapted to transmit and receive data, respectively. The control circuitry 105 may be adapted or configured to perform various operations such as those described elsewhere in this disclosure related to a UE. The transmit circuitry 110 may transmit a plurality of multiplexed uplink physical channels. The plurality of uplink physical channels may be multiplexed according to time division multiplexing (TDM) or frequency division multiplexing (FDM). The transmit circuitry 110 may be configured to receive block data from the control circuitry 105 for transmission across the air interface 190. Similarly, the receive circuitry 115 may receive a plurality of multiplexed downlink physical channels from the air interface 190 and relay the physical channels to the control circuitry 105. The uplink and downlink physical channels may be multiplexed according to TDM or FDM. The transmit circuitry 110 and the receive circuitry 115 may transmit and receive both control data and content data (e.g., messages, images, video, et cetera) structured within data blocks that are carried by the physical channels.

FIG. 1 also illustrates the base station 150, in accordance with various embodiments. The base station 150 circuitry may include control circuitry 155 coupled with transmit circuitry 160 and receive circuitry 165. The transmit circuitry 160 and receive circuitry 165 may each be coupled with one or more antennas that may be used to enable communications via the air interface 190.

The control circuitry 155 may be adapted to perform operations associated with MTC. The transmit circuitry 160 and receive circuitry 165 may be adapted to transmit and receive data, respectively, within a narrow system bandwidth that is narrower than a standard bandwidth structured for person-to-person communication. In some embodiments, for example, a transmission bandwidth may be set at or near 1.4 MHz. In other embodiments, other bandwidths may be used. The control circuitry 155 may perform various operations such as those described elsewhere in this disclosure related to a base station.

Within the narrow system bandwidth, the transmit circuitry 160 may transmit a plurality of multiplexed downlink physical channels. The plurality of downlink physical channels may be multiplexed according to TDM or FDM. The transmit circuitry 160 may transmit the plurality of multiplexed downlink physical channels in a downlink super-frame that is included of a plurality of downlink subframes.

Within the narrow system bandwidth, the receive circuitry 165 may receive a plurality of multiplexed uplink physical channels. The plurality of uplink physical channels may be multiplexed according to TDM or FDM. The receive circuitry 165 may receive the plurality of multiplexed uplink physical channels in an uplink super-frame that is included of a plurality of uplink subframes.

As described further below, the control circuitry 105 and ESS may be involved with measurement of a channel quality for the air interface 190. The channel quality may, for example, be based on physical obstructions between the UE 101 and the base station 150, electromagnetic signal interference from other sources, reflections or indirect paths between the UE 101 and the base station 150, or other such sources of signal noise. Based on the channel quality, a block of data may be scheduled to be retransmitted multiple times, such that the transmit circuitry 110 may transmit copies of the same data multiple times and the receive circuitry 115 may receive multiple copies of the same data multiple times.

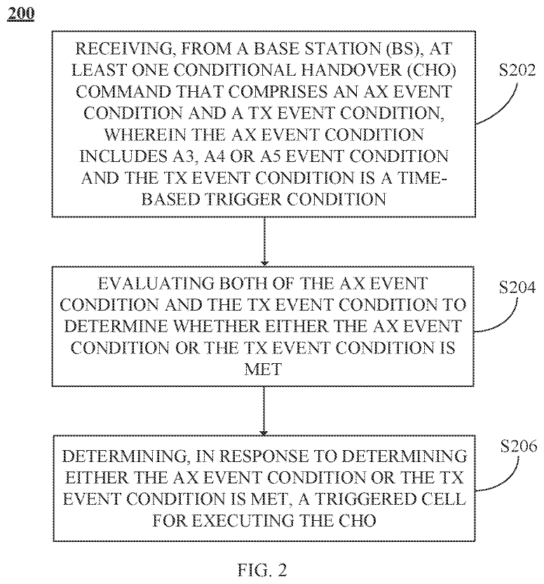

FIG. 2 illustrates a flowchart for an exemplary method for a UE in accordance with some embodiments. In some embodiment, the method 200 illustrated in FIG. 2 may be implemented by the UE 101 described in FIG. 1.

In some embodiments, as shown in FIG. 2, the method 200 for a UE includes the following steps: S202, receiving, from a base station (BS), at least one conditional handover (CHO) command that comprises an Ax event condition and a Tx event condition (note that the Tx event can only be configured together with the Ax event), wherein the Ax event condition includes A3, A4 or A5 event condition and the Tx event condition is a time-based trigger condition; S204, evaluating both of the Ax event condition and the Tx event condition to determine whether either the Ax event condition or the Tx event condition is met; and S206, in response to determining either the Ax event condition or the Tx event condition is met, determining a triggered cell for executing a CHO.

According to the method of some embodiments of the present disclosure, with the help of the Ax event condition and the Tx event condition included in the at least one CHO command, time-based CHO trigger event can be implemented in the case of TN. Furthermore, the UE can implement a relaxed CHO condition since a CHO procedure is initiated when either the Ax event condition or the Tx event condition is met.

In the following, each step of the method 200 will be described in detail.

At step S202, the UE receives at least one conditional handover (CHO) command that comprises an Ax event condition and a Tx event condition from a base station (BS), wherein the Ax event condition includes A3, A4 or A5 event condition and the Tx event condition is a time-based trigger condition.

At step S204, the UE evaluates both of the Ax event condition and the Tx event condition to determine whether either the Ax event condition or the Tx event condition is met.

At step S206, in response to determining either the Ax event condition or the Tx event condition is met, the UE determines a triggered cell for executing a CHO.

In some embodiments, the UE may be a UE which doesn't support GNSS. For example, the UE may be an NES UE which doesn't support GNSS or a IAB UE which doesn't support GNSS.

In the embodiments that the UE is an NES UE, the method 200 can allow the NES UE to apply a relaxed CHO condition from a fixed time when the source cell can't well serve the UE. The fixed time may be a time when the source cell is planned to turn off (which means the source cell can't serve UE after turning off). The fixed time may also be a time when the source cell is planned to activate cell discontinuous transmission (DTX) or discontinuous reception (DRX) with long non-active duration (which means the UE's quality of service (QoS) may be degraded in the source cell).

In the embodiments that the UE is a IAB UE, the method 200 can distribute mobility events of onboard UEs to avoid random access channel (RACH) collision.

In some embodiments, whether the UE supports GNSS may be derived via UE capability reporting.

In some embodiments, when a plurality of the triggered cells are existed, one of the plurality of the triggered cells may be selected based on UE implementation. In this way, the selected cell can provide a better channel quality.

In some embodiments, the Tx event condition may comprise a T1 event condition including a T1 threshold and a first time duration using a universal time coordinated (UTC) time. The UTC time may be included in a radio resource control (RRC) message and may be the time in upcoming system frame number (SFN) boundary of a source cell. Alternatively, the UTC time may be acquirable from a system information block Type 9 (SIB9). Therefore, the UE is able to get the UTC timing from the BS. The Tx event condition is met when a time measured at the UE becomes more than the T1 threshold but is less than a sum of the T1 threshold and the first time duration.

In some embodiments, the base station may also send, via the RRC message, the UTC time together with the at least one CHO command to a UE which doesn't support GNSS.

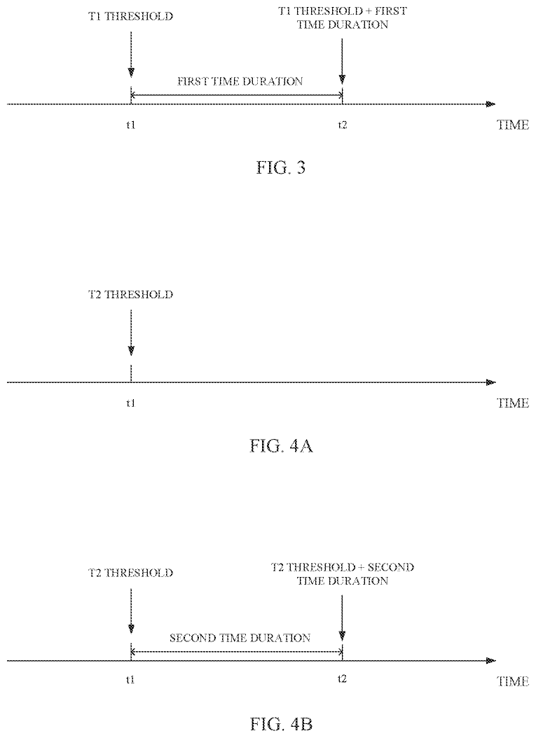

FIG. 3 illustrates an exemplary diagram of T1 event condition in accordance with some embodiments. Referring to FIG. 3, t1 is the time of the T1 threshold and t2 is the time of the first time duration after the T1 threshold. The Tx event condition is met when the time measured at the UE for handover lies between t1 and t2.

In some embodiments, the Tx event condition may comprise a T2 event condition including a T2 threshold based on a source cell, and wherein the Tx event condition is met when a time measured at the UE becomes more than the T2 threshold.

FIG. 4A illustrates an exemplary diagram of T2 event condition in accordance with some embodiments. Referring to FIG. 4A, t1 is the time of the T2 threshold. The Tx event condition is met when the time measured at the UE for handover lies after t1.

In some embodiments, the T2 event condition may further include a second time duration configured based on one of a slot, a subframe and an absolute time. That is, the second time duration may be x slots, x subframe or x absolute time (e.g. in millisecond). The Tx event condition is met when a time measured at the UE becomes more than the T2 threshold but is less than a sum of the T2 threshold and the second time duration.

FIG. 4B illustrates another exemplary diagram of T2 event condition in accordance with some embodiments. Referring to FIG. 4B, t1 is the time of the T2 threshold and t2 is the time of the second time duration after the T2 threshold. The Tx event condition is met when the time measured at the UE for handover lies between t1 and t2.

In some embodiments, the T2 threshold may be source cell based. The T2 threshold may be configured based on: a system frame number (SFN) index of the source cell and a slot index (i.e., SFN index+slot index), the SFN index and a subframe index (i.e., SFN index+subframe index), the SFN index and an absolute time offset (i.e., SFN index+absolute time offset (e.g., in ms)), a hyper SFN (H-SFN) index of the source cell, the SEN index and the slot index (i.e., H-SFN+SFN+slot index), the H-SFN index, the SFN index and the subframe index (i.e., H-SFN+SFN+subframe index) or the H-SFN index, the SFN index and the absolute time offset (i.e., H-SFN+SFN+absolute time offset (e.g., in ms)).

In some embodiments, the Tx event condition may comprise a T3 event condition including a timer with an expiration time which starts upon a reception time of the CHO command by the UE. The expiration time may be configured based on one of a slot, a subframe and an absolute time. That is, the expiration time may be x slots, x subframe or x absolute time (e.g. in millisecond). The Tx event condition is met when a time measured at the UE becomes more than a sum of the reception time and the expiration time.

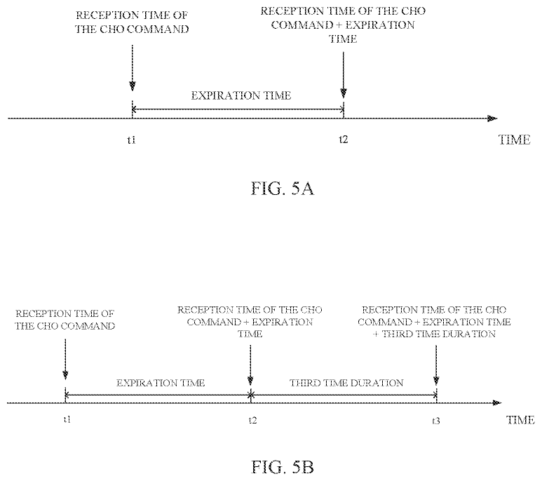

FIG. 5A illustrates an exemplary diagram of T3 event condition in accordance with some embodiments. Referring to FIG. 5A, t1 is the time of the T3 threshold and t2 is the time of the expiration time after the T3 threshold. The Tx event condition is met when the time measured at the UE for handover lies after t2.

In some embodiments, the T3 event condition may further include a third time duration configured based on one of a slot, a subframe and an absolute time. That is, the third time duration may be x slots, x subframe or x absolute time (e.g. in millisecond). The Tx event condition is met when a time measured at the UE becomes more than a sum of the reception time of the expiration time but is less than a sum of the reception time, the expiration time and the third time duration.

FIG. 5B illustrates another exemplary diagram of T3 event condition in accordance with some embodiments. Referring to FIG. 5B, t1 is the time of the T3 threshold, t2 is the time of the expiration time after the T3 threshold, and t3 is the time of the third time duration after the t2. The Tx event condition is met when the time measured at the UE for handover lies between t2 and t3.

According to some embodiments, by using the Tx event condition, a CHO execution time of the UE can be scattered for HO load distribution consideration.

In some embodiments, the step S206 may comprise: in response to determining the Ax event condition is met while the Tx event condition is not met, considering a candidate cell that meets the Ax event condition as the triggered cell. The step S206 is described in detail below with continued reference to FIG. 3 to FIG. 5B. Referring to FIG. 3, if the Ax event condition is met while the time measured at UE lies before t1 or after 12, the UE considers a candidate cell that meets the Ax event condition as the triggered cell. Referring to FIG. 4A, if the Ax event condition is met while the time measured at UE lies before t1, the UE considers a candidate cell that meets the Ax event condition as the triggered cell. Referring to FIG. 4B, if the Ax event condition is met while the time measured at UE lies before t1 or after t2, the UE considers a candidate cell that meets the Ax event condition as the triggered cell. Referring to FIG. 5A, if the Ax event condition is met while the time measured at UE lies before t2, the UE considers a candidate cell that meets the Ax event condition as the triggered cell. Referring to FIG. 5B, if the Ax event condition is met while the time measured at UE lies before t2 or after t3, the UE considers a candidate cell that meets the Ax event condition as the triggered cell.

Another case regarding a determination that the Tx event condition is met while the Ax event condition is not met is described in detail below with continued reference to FIG. 3 to FIG. 5B. Referring to FIG. 3, it may be the case that the Ax event condition has not been met but the time measured at UE lies between t1 and t2. Referring to FIG. 4A, it may be the case that the Ax event condition has not been met but the time measured at UE lies after t1. Referring to FIG. 4B, it may be the case that the Ax event condition has not been met but the time measured at UE lies between t1 and t2. Referring to FIG. 5A, it may be the case that the Ax event condition has not been met but the time measured at UE lies after t2. Referring to FIG. 5B, it may be the case that the Ax event condition has not been met but the time measured at UE lies between t2 and t3.

In some embodiments, the step S206 may comprise: in response to determining the Tx event condition is met while the Ax event condition is not met, determining whether an additional Ax event condition with a network energy saving (NES) specific threshold included in the CHO command is met; and in response to determining the additional Ax event condition is met, considering a candidate cell that meets the additional Ax event condition as the triggered cell. In an example, the Ax event condition is not indicated as “NES”, while the additional Ax event condition is indicated as “NES”. The additional Ax event condition is configured to be evaluated only when the Tx event condition is met. In an example, the method of these embodiments allows up to 3 CHO conditions (i.e., a Tx event condition, an Ax event condition and an additional Ax event condition), and is suitable for the case that the source cell is to activate cell DTX/DRX.

In some embodiments, the additional Ax event condition is of the same type as the Ax event condition but with a different event threshold, or the additional Ax event condition is of a different type with the Ax event condition. For example, the Ax event condition may be an A5 event condition and the additional Ax event condition may also be an A5 event condition. However, the additional Ax event condition may have a more relaxed A5 threshold than the Ax event condition, so that it is easier to initiate a CHO procedure based on the additional Ax event. For another example, the Ax event condition may be an A5 event condition and the additional Ax event condition may be a more relaxed A4 event condition. Such a configuration also makes it easier to initiate a CHO procedure based on the additional Ax event.

In an example, the above process may be configured as follows:

```
  2>if any condEventId, within condExecutionCond associated to condReconfigId, is
associated with condEventTx:
    3>if A3 or A4 or A5 event associated to measId not indicated as “NES” within
  condTriggerConfig for a target candidate cell within the stored condRRCReconfig are
  fulfilled:
      4> consider the target candidate cell within the stored condRRCReconfig,
    associated to that condReconfigId, as a triggered cell;
      4> initiate the conditional reconfiguration execution, as specified in 5.3.5.13.5;
  3> Else if Tx event(s) associated to measId(s) within condTriggerConfig for a target
candidate cell within the stored condRRCReconfig is fulfilled:
    4> If A3 or A4 or A5 event associated to measId indicated as “NES” within
  condTriggerConfig for a target candidate cell within the stored condRRCReconfig are
  fulfilled:
      5> consider the target candidate cell within the stored condRRCReconfig,
    associated to that condReconfigId, as a triggered cell;
      5> initiate the conditional reconfiguration execution, as specified in 5.3.5.13.5.
```

In some embodiments, the step S206 may comprise: in response to determining the Tx event condition is met the while the Ax event condition is not met, applying a threshold offset to the Ax event condition; determining whether the Ax event condition with the threshold offset is met; and in response to determining the Ax event condition with the threshold offset is met, considering a candidate cell that meets the Ax event condition with the threshold offset as the triggered cell. The threshold may be configured differently with consideration of whether the source cell is cell off or cell DTX/DRX. By applying a threshold offset to the threshold of the Ax event condition, a more relaxed new threshold can be implemented. In this way, it is easier to initiate a CHO procedure based on the relaxed new threshold and there is no need of up to 3 CHO conditions. The method of these embodiments is suitable for the case that the source cell is to activate cell DTX/DRX.

In an example, the above process may be configured as follows:

```
  2>if any condEventId, within condExecutionCond associated to condReconfigId, is
associated with condEventTx:
    3>if A3 or A4 or A5 event associated to measId within condTriggerConfig for a target
  candidate cell within the stored condRRCReconfig are fulfilled:
      4> consider the target candidate cell within the stored condRRCReconfig,
    associated to that condReconfigId, as a triggered cell;
      4> initiate the conditional reconfiguration execution, as specified in 5.3.5.13.5;
    3> Else if Tx event(s) associated to measId(s) within condTriggerConfig for a target
  candidate cell within the stored condRRCReconfig is fulfilled:
      4> The UE applies the configured threshold offset to the evaluated A3 or A4 or A5
    event associated to measId within condTriggerConfig
      4> if A3 or A4 or A5 event associated to measid within condTriggerConfig are
    fulfilled:
        5> consider the target candidate cell within the stored condRRCReconfig,
      associated to that condReconfigId, as a triggered cell;
        5> initiate the conditional reconfiguration execution, as specified in
      5.3.5.13.5.
```

In some embodiments, the step S206 may comprise: in response to determining the Tx event condition is met the while the Ax event condition is not met, determining whether a reference signal receiving power (RSRP) threshold or a reference signal receiving quality (RSRQ) threshold included in the CHO command is met; in response to determining the RSRP threshold or RSRQ threshold is met (i.e., a target candidate cell's RSRP is larger than or equal to the RSRP threshold, or a target candidate cell's RSRQ is larger than or equal to the RSRQ threshold), considering a candidate cell that meets the RSRP threshold or RSRQ threshold as the triggered cell. In this way, even if no candidate target cell meets the Ax event condition, a second chance (i.e., considering RSRP or RSRQ) to initiate a CHO procedure can be provided.

In an example, the above process may be configured as follows:

```
  3>if A3 or A4 or A5 event associated to measId within condTriggerConfig for a target
candidate cell within the stored condRRCReconfig are fulfilled:
    4> consider the target candidate cell within the stored condRRCReconfig, associated to
  that condReconfigId, as a triggered cell;
    4> initiate the conditional reconfiguration execution, as specified in 5.3.5.13.5;
  3> Else if Tx event(s) associated to measId(s) within condTriggerConfig for a target
candidate cell within the stored condRRCReconfig is fulfilled:
    4> If the target candidate cell's RSRP or RSRQ is larger than or equal to the
  configured Threshold Th:
      5> consider the target candidate cell within the stored condRRCReconfig,
    associated to that condReconfigId, as a triggered cell;
      5> initiate the conditional reconfiguration execution, as specified in 5.3.5.13.5.
```

In some embodiments, the RSRP threshold or RSRQ threshold may comprise an S criteria indicated in an SIB of the source cell. Whether a candidate cell is a suitable cell is determined by checking whether Srxlev>0 AND Squal>0. Alternatively, the RSRP threshold or RSRQ threshold may be a new threshold included in the CHO command. The method of these embodiments is suitable for the case of mobile IAB or for the case that the source cell is cell off and there is no need of up to 3 CHO conditions.

In some embodiments, whether the UE is to evaluate the additional Ax event condition, to apply the threshold offset to the Ax event condition or to determine the RSRP threshold or RSRQ threshold may be indicated in the Tx event condition, the CHO command or a RRC message.

In some embodiments, when in absence of the Tx event condition, the method 200 may comprise: in response to determining that the Ax event condition is met or an L1/L2 signaling from a source cell that is used to trigger the CHO execution is received, determining the triggered cell for executing the CHO. That is, in this case the UE may be configured with up to two CHO Ax events only. In an example, such an operation may be similar to the operation described regarding FIG. 4A, and the difference is that the t1 in FIG. 4A may be changed to a time when the L1/L2 signaling is received rather than the T1 threshold. The L1/L2 signaling is UE group common or cell common downlink control information (DCI)/medium access control-control element (MAC-CE).

In some embodiments, when in absence of the Tx event condition, the method 200 may comprise: in response to determining that the Ax event condition is met or an indication, used to trigger the CHO execution, in a system information block (SIB) of a source cell is received, determining the triggered cell for executing the CHO. That is, in this case the UE may be also configured with up to two CHO Ax events only. Such an operation may be also similar to the operation described regarding FIG. 4A, but the difference is that the t1 in FIG. 4A may be changed to a time when the SIB is received rather than the T1 threshold.

In some embodiments, when in absence of the Tx event condition, the method 200 may further comprise the following operations. In response to determining the L1/L2 signaling or the indication in the SIB is received while the Ax event condition is not met (e.g., the Ax event condition has not been met but the time measured at UE lies after t1 in FIG. 4A, where t1 is the time when the L1/L2 signaling or the indication in the SIB is received), the UE may perform one of the following operations: evaluating an additional Ax event condition with an NES specific threshold included in the CHO command to determine the triggered cell; applying a threshold offset to the Ax event condition to determine the triggered cell; or determining whether a RSRP threshold or a RSRQ threshold included in the CHO command is met to determine the triggered cell. These operations can be referred to the description of step S206 above and therefore are omitted. Whether the UE is to evaluate the additional Ax event condition, to apply the threshold offset to the Ax event condition or to determine the RSRP threshold or RSRQ threshold is indicated in a RRC message for reception of the L1/L2 signaling, or is indicated in the indication in the L1/L2 signaling, or is indicated in the indication in the SIB for reception of the indication in the SIB.

In an example, the above process may be configured as follows:

```
  In the case of evaluating the additional Ax event condition:
  3>if A3 or A4 or A5 event associated to measId not indicated as “NES” within
condTriggerConfig for a target candidate cell within the stored condRRCReconfig are fulfilled:
    4> consider the target candidate cell within the stored condRRCReconfig, associated to
  that condReconfigId, as a triggered cell;
    4> initiate the conditional reconfiguration execution, as specified in 5.3.5.13.5;
  3> Else if upon reception of L1/L2 signaling / upon detection of indication change in SIB:
    4> If A3 or A4 or A5 event associated to measld indicated as “NES” within
  condTriggerConfig for a target candidate cell within the stored condRRCReconfig are
  fulfilled:
      5> consider the target candidate cell within the stored condRRCReconfig,
    associated to that condReconfigId, as a triggered cell;
      5> initiate the conditional reconfiguration execution, as specified in 5.3.5.13.5.
  In the case of applying the threshold offset to the Ax event condition:
  3>if A3 or A4 or A5 event associated to measId within condTriggerConfig for a target
candidate cell within the stored condRRCReconfig are fulfilled:
    4> consider the target candidate cell within the stored condRRCReconfig, associated to
  that condReconfigId, as a triggered cell;
    4> initiate the conditional reconfiguration execution, as specified in 5.3.5.13.5;
  3> Else if upon reception of L1/L2 signaling / upon detection of indication change in SIB:
    4> The UE applies the configured threshold offset to the evaluated A3 or A4 or A5 event
  associated to measId within condTriggerConfig
    4> if A3 or A4 or A5 event associated to measId within condTriggerConfig are fulfilled:
      5> consider the target candidate cell within the stored condRRCReconfig,
    associated to that condReconfigId, as a triggered cell;
      5> initiate the conditional reconfiguration execution, as specified in 5.3.5.13.5.
  In the case of determining the RSRP threshold or RSRQ threshold:
  3>if A3 or A4 or A5 event associated to measId within condTriggerConfig for a target
candidate cell within the stored condRRCReconfig are fulfilled:
    4> consider the target candidate cell within the stored condRRCReconfig, associated to
  that condReconfigId, as a triggered cell;
    4> initiate the conditional reconfiguration execution, as specified in 5.3.5.13.5;
  3> Else if upon reception of L1/L2 signaling / upon detection of indication change in SIB:
    4> If the target candidate cell's RSRP or RSRQ is larger than or equal to the
  configured Threshold Th:
      5> consider the target candidate cell within the stored condRRCReconfig,
    associated to that condReconfigId, as a triggered cell;
      5> initiate the conditional reconfiguration execution, as specified in 5.3.5.13.5.
```

In some embodiments, an apparatus for a user equipment (UE) may comprise one or more processors configured to perform operations comprising: receiving, from a base station (BS), at least one conditional handover (CHO) command that comprises an Ax event condition and a Tx event condition, wherein the Ax event condition includes A3, A4 or A5 event condition and the Tx event condition is a time-based trigger condition; evaluating both of the Ax event condition and the Tx event condition to determine whether either the Ax event condition or the Tx event condition is met; and determining, in response to determining either the Ax event condition or the Tx event condition is met, a triggered cell for executing a CHO.

In some embodiments, a computer readable medium may have computer programs stored thereon which, when executed by one or more processors, cause the one or more processors to perform operations comprising: receiving, from a base station (BS), at least one conditional handover (CHO) command that comprises an Ax event condition and a Tx event condition, wherein the Ax event condition includes A3, A4 or A5 event condition and the Tx event condition is a time-based trigger condition; evaluating both of the Ax event condition and the Tx event condition to determine whether either the Ax event condition or the Tx event condition is met; and determining, in response to determining either the Ax event condition or the Tx event condition is met, a triggered cell for executing a CHO.

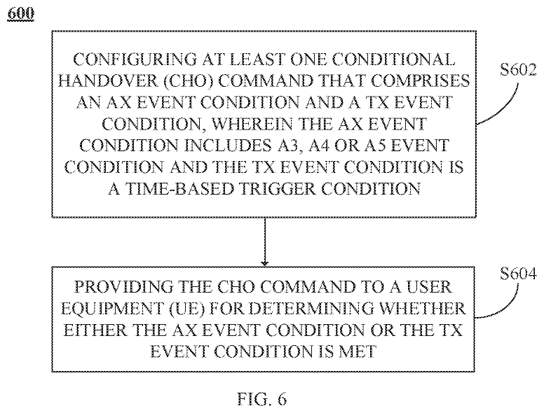

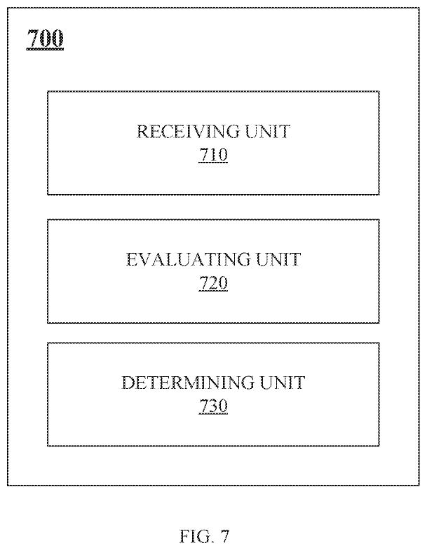

FIG. 6 illustrates a flowchart for an exemplary method for a base station in accordance with some embodiments. The method 600 illustrated in FIG. 6 may be implemented by the base station 150 described in FIG. 1.

In some embodiments, the method 600 for a BS may include the following steps: S602, configuring at least one conditional handover (CHO) command that comprises an Ax event condition and a Tx event condition, wherein the Ax event condition includes A3, A4 or A5 event condition and the Tx event condition is a time-based trigger condition; and S604, providing the CHO command to a user equipment (UE) for determining whether either the Ax event condition or the Tx event condition is met.

In the following, each step of the method 600 will be described. Note that those elements, expressions, features etc. that have already been described with reference to FIG. 2 and the corresponding description (about the UE) are omitted for clarity.

At step S602, the base station configures at least one conditional handover (CHO) command which comprises an Ax event condition and a Tx event condition. The Ax event condition includes A3, A4 or A5 event condition and the Tx event condition is a time-based trigger condition.

At step S604, the base station provides the CHO command to a user equipment (UE) for determining whether either the Ax event condition or the Tx event condition is met.

According to the method of some embodiments of the present disclosure, by providing to the UE with the Ax event condition and the Tx event condition included in the at least one CHO command, time-based CHO trigger event can be implemented in the case of TN. Furthermore, the UE can implement a relaxed CHO condition since a CHO procedure is initiated when either the Ax event condition or the Tx event condition is met.

In some embodiments, the Tx event condition in the method 600 may comprise one of: a T1 event condition including a T1 threshold and a first time duration using a universal time coordinated (UTC) time; a T2 event condition including a T2 threshold based on a source cell; a T2 event condition including a T2 threshold based on a source cell and a second time duration configured based on one of a slot, a subframe and an absolute time; a T3 event condition including a timer with an expiration time which starts upon a reception time of the CHO command by the UE; a T3 event condition including a timer with an expiration time which starts upon a reception time of the CHO command by the UE and a third time duration configured based on one of a slot, a subframe and an absolute time. Details in respective to the T1-T3 event condition and the first time duration to third time duration have already been described with reference to the method 200 and the corresponding description are omitted for clarity.

In some embodiments, the method 600 may further comprise providing a radio resource control (RRC) message including the UTC time to the UE.

In some embodiments, an apparatus for a BS may comprise one or more processors configured to perform operations comprising: configuring at least one conditional handover (CHO) command that comprises an Ax event condition and a Tx event condition, wherein the Ax event condition includes A3, A4 or A5 event condition and the Tx event condition is a time-based trigger condition; and providing the CHO command to a user equipment (UE) for determining whether either the Ax event condition or the Tx event condition is met.

In some embodiments, a computer readable medium may have computer programs stored thereon which, when executed by one or more processors, cause the one or more processors to perform operations comprising: configuring at least one conditional handover (CHO) command that comprises an Ax event condition and a Tx event condition, wherein the Ax event condition includes A3, A4 or A5 event condition and the Ts event condition is a time-based trigger condition; and providing the CHO command to a user equipment (UE) for determining whether either the Ax event condition or the Tx event condition is met.

FIG. 7 illustrates an exemplary block diagram of an apparatus for a UE in accordance with some embodiments. The apparatus 700 illustrated in FIG. 7 may be used to implement the method 200 as illustrated in combination with FIG. 2.

As illustrated in FIG. 7, the apparatus 700 includes a receiving unit 710, an evaluating unit 720 and a determining unit 730.

The receiving unit 710 is configured to receive at least one conditional handover (CHO) command comprises an Ax event condition and a Tx event condition from a base station (BS), wherein the Ax event condition includes A3, A4 or A5 event condition and the Tx event condition is a time-based trigger condition.

The evaluating unit 720 is configured to evaluate both of the Ax event condition and the Tx event condition to determine whether either the Ax event condition or the Tx event condition is met.

The determining unit 730 is configured to determine a triggered cell for executing a CHO in response to determining either the Ax event condition or the Tx event condition is met.

According to the apparatus of some embodiments of the present disclosure, with the help of the Ax event condition and the Tx event condition included in the at least one CHO command, time-based CHO trigger event can be implemented in the case of TN. Furthermore, the UE can implement a relaxed CHO condition since a CHO procedure is initiated when either the Ax event condition or the Tx event condition is met.

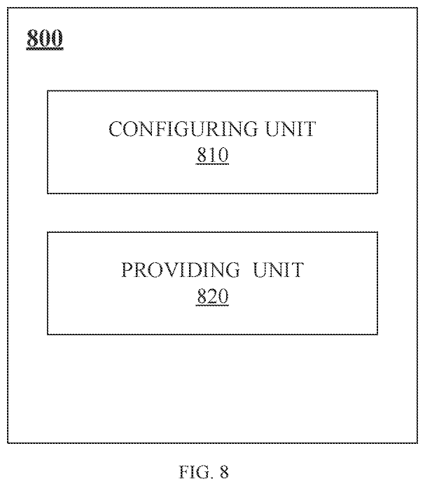

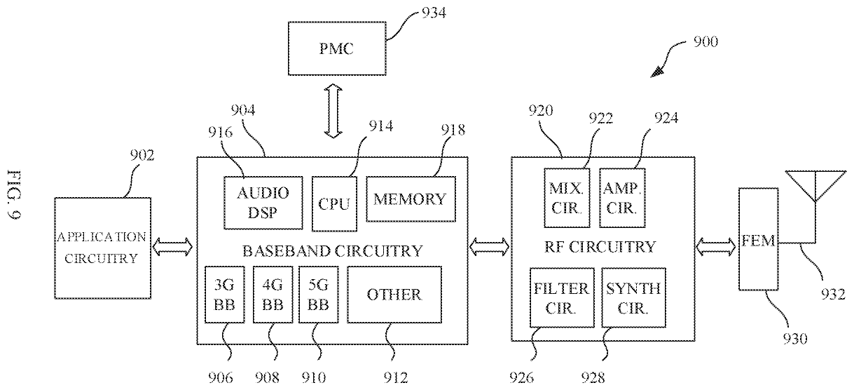

FIG. 8 illustrates an exemplary block diagram of an apparatus for a BS in accordance with some embodiments. The apparatus 800 illustrated in FIG. 8 may be used to implement the method 600 as illustrated in combination with FIG. 6.

As illustrated in FIG. 8, the apparatus 800 includes a configuring unit 810 and a providing unit 820.

The configuring unit 810 is configured to configuring at least one conditional handover (CHO) command that comprises an Ax event condition and a Tx event condition, wherein the Ax event condition includes A3, A4 or A5 event condition and the Tx event condition is a time-based trigger condition.

The providing unit 820 is configured to provide the CHO command to a user equipment (UE) for determining whether either the Ax event condition or the Tx event condition is met.

According to the apparatus of some embodiments of the present disclosure, by providing to the UE with the Ax event condition and the Tx event condition included in the at least one CHO command, time-based CHO trigger event can be implemented in the case of TN. Furthermore, the UE can implement a relaxed CHO condition since a CHO procedure is initiated when either the Ax event condition or the Tx event condition is met.

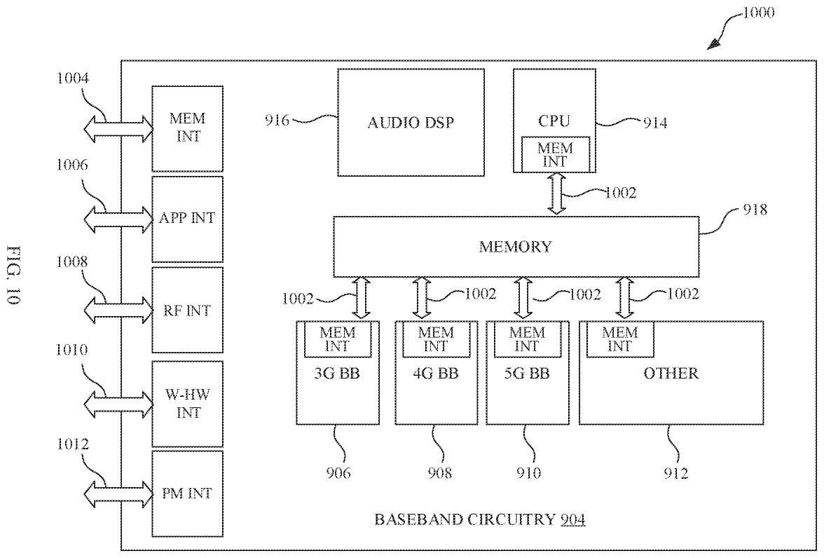

FIG. 9 illustrates example components of a device 900 in accordance with some embodiments. In some embodiments, the device 900 may include application circuitry 902, baseband circuitry 904, Radio Frequency (RF) circuitry (shown as RF circuitry 920), front-end module (FEM) circuitry (shown as FEM circuitry 930), one or more antennas 932, and power management circuitry (PMC) (shown as PMC 934) coupled together at least as shown. The components of the illustrated device 900 may be included in a UE or a RAN node. In some embodiments, the device 900 may include fewer elements (e.g., a RAN node may not utilize application circuitry 902, and instead include a processor/controller to process IP data received from an EPC). In some embodiments, the device 900 may include additional elements such as, for example, memory/storage, display, camera, sensor, or input/output (I/O)) interface. In other embodiments, the components described below may be included in more than one device (e.g., said circuitries may be separately included in more than one device for Cloud-RAN (C-RAN) implementations).

The application circuitry 902 may include one or more application processors. For example, the application circuitry 902 may include circuitry such as, but not limited to, one or more single-core or multi-core processors. The processor(s) may include any combination of general-purpose processors and dedicated processors (e.g., graphics processors, application processors, etc.). The processors may be coupled with or may include memory/storage and may be configured to execute instructions stored in the memory/storage to enable various applications or operating systems to run on the device 900. In some embodiments, processors of application circuitry 902 may process IP data packets received from an EPC.

The baseband circuitry 904 may include circuitry such as, but not limited to, one or more single-core or multi-core processors. The baseband circuitry 904 may include one or more baseband processors or control logic to process baseband signals received from a receive signal path of the RF circuitry 920 and to generate baseband signals for a transmit signal path of the RF circuitry 920. The baseband circuitry 904 may interface with the application circuitry 902 for generation and processing of the baseband signals and for controlling operations of the RF circuitry 920. For example, in some embodiments, the baseband circuitry 904 may include a third generation (3G) baseband processor (3G baseband processor 906), a fourth generation (4G) baseband processor (4G baseband processor 908), a fifth generation (5G) baseband processor (5G baseband processor 910), or other baseband processor(s) 912 for other existing generations, generations in development or to be developed in the future (e.g., second generation (2G), sixth generation (6G), etc.). The baseband circuitry 904 (e.g., one or more of baseband processors) may handle various radio control functions that enable communication with one or more radio networks via the RF circuitry 920. In other embodiments, some or all of the functionality of the illustrated baseband processors may be included in modules stored in the memory 918 and executed via a Central Processing Unit (CPU 914). The radio control functions may include, but are not limited to, signal modulation/demodulation, encoding/decoding, radio frequency shifting, etc. In some embodiments, modulation/demodulation circuitry of the baseband circuitry 904 may include Fast-Fourier Transform (FFT), precoding, or constellation mapping/demapping functionality. In some embodiments, encoding/decoding circuitry of the baseband circuitry 904 may include convolution, tail-biting convolution, turbo, Viterbi, or Low Density Parity Check (LDPC) encoder/decoder functionality. Embodiments of modulation/demodulation and encoder/decoder functionality are not limited to these examples and may include other suitable functionality in other embodiments.

In some embodiments, the baseband circuitry 904 may include a digital signal processor (DSP), such as one or more audio DSP(s) 916. The one or more audio DSP(s) 916 may include elements for compression/decompression and echo cancellation and may include other suitable processing elements in other embodiments. Components of the baseband circuitry may be suitably combined in a single chip, a single chipset, or disposed on a same circuit board in some embodiments. In some embodiments, some or all of the constituent components of the baseband circuitry 904 and the application circuitry 902 may be implemented together such as, for example, on a system on a chip (SOC).

In some embodiments, the baseband circuitry 904 may provide for communication compatible with one or more radio technologies. For example, in some embodiments, the baseband circuitry 904 may support communication with an evolved universal terrestrial radio access network (EUTRAN) or other wireless metropolitan area networks (WMAN), a wireless local area network (WLAN), or a wireless personal area network (WPAN). Embodiments in which the baseband circuitry 904 is configured to support radio communications of more than one wireless protocol may be referred to as multi-mode baseband circuitry.

The RF circuitry 920 may enable communication with wireless networks using modulated electromagnetic radiation through a non-solid medium. In various embodiments, the RF circuitry 920 may include switches, filters, amplifiers, etc. to facilitate the communication with the wireless network. The RF circuitry 920 may include a receive signal path which may include circuitry to down-convert RF signals received from the FEM circuitry 930 and provide baseband signals to the baseband circuitry 904. The RF circuitry 920 may also include a transmit signal path which may include circuitry to up-convert baseband signals provided by the baseband circuitry 904 and provide RF output signals to the FEM circuitry 930 for transmission.

In some embodiments, the receive signal path of the RF circuitry 920 may include miser circuitry 922, amplifier circuitry 924 and filter circuitry 926. In some embodiments, the transmit signal path of the RF circuitry 920 may include filter circuitry 926 and mixer circuitry 922. The RF circuitry 920 may also include synthesizer circuitry 928 for synthesizing a frequency for use by the mixer circuitry 922 of the receive signal path and the transmit signal path. In some embodiments, the mixer circuitry 922 of the receive signal path may be configured to down-convert RF signals received from the FEM circuitry 930 based on the synthesized frequency provided by synthesizer circuitry 928. The amplifier circuitry 924 may be configured to amplify the down-converted signals and the filter circuitry 926 may be a low-pass filter (LPF) or band-pass filter (BPF) configured to remove unwanted signals from the down-converted signals to generate output baseband signals. Output baseband signals may be provided to the baseband circuitry 904 for further processing. In some embodiments, the output baseband signals may be zero-frequency baseband signals, although this is not a requirement. In some embodiments, the mixer circuitry 922 of the receive signal path may include passive mixers, although the scope of the embodiments is not limited in this respect.

In some embodiments, the mixer circuitry 922 of the transmit signal path may be configured to up-convert input baseband signals based on the synthesized frequency provided by the synthesizer circuitry 928 to generate RF output signals for the FEM circuitry 930. The baseband signals may be provided by the baseband circuitry 904 and may be filtered by the filter circuitry 926.

In some embodiments, the mixer circuitry 922 of the receive signal path and the mixer circuitry 922 of the transmit signal path may include two or more mixers and may be arranged for quadrature downconversion and upconversion, respectively. In some embodiments, the mixer circuitry 922 of the receive signal path and the mixer circuitry 922 of the transmit signal path may include two or more mixers and may be arranged for image rejection (e.g., Hartley image rejection). In some embodiments, the mixer circuitry 922 of the receive signal path and the mixer circuitry 922 may be arranged for direct downconversion and direct upconversion, respectively. In some embodiments, the mixer circuitry 922 of the receive signal path and the mixer circuitry 922 of the transmit signal path may be configured for super-heterodyne operation.

In some embodiments, the output baseband signals and the input baseband signals may be analog baseband signals, although the scope of the embodiments is not limited in this respect. In some alternate embodiments, the output baseband signals and the input baseband signals may be digital baseband signals. In these alternate embodiments, the RF circuitry 920 may include analog-to-digital converter (ADC) and digital-to-analog converter (DAC) circuitry and the baseband circuitry 904 may include a digital baseband interface to communicate with the RF circuitry 920.

In some dual-mode embodiments, a separate radio IC circuitry may be provided for processing signals for each spectrum, although the scope of the embodiments is not limited in this respect.

In some embodiments, the synthesizer circuitry 928 may be a fractional −N synthesizer or a fractional N/N+1 synthesizer, although the scope of the embodiments is not limited in this respect as other types of frequency synthesizers may be suitable. For example, synthesizer circuitry 928 may be a delta-sigma synthesizer, a frequency multiplier, or a synthesizer including a phase-locked loop with a frequency divider.

The synthesizer circuitry 928 may be configured to synthesize an output frequency for use by the mixer circuitry 922 of the RF circuitry 920 based on a frequency input and a divider control input. In some embodiments, the synthesizer circuitry 928 may be a fractional N/N+1 synthesizer.

In some embodiments, frequency input may be provided by a voltage controlled oscillator (VCO), although that is not a requirement. Divider control input may be provided by either the baseband circuitry 904 or the application circuitry 902 (such as an applications processor) depending on the desired output frequency. In some embodiments, a divider control input (e.g., N) may be determined from a look-up table based on a channel indicated by the application circuitry 902.

Synthesizer circuitry 928 of the RF circuitry 920 may include a divider, a delay-locked loop (DLL), a multiplexer and a phase accumulator. In some embodiments, the divider may be a dual modulus divider (DMD) and the phase accumulator may be a digital phase accumulator (DPA). In some embodiments, the DMD may be configured to divide the input signal by either N or N+1 (e.g., based on a carry out) to provide a fractional division ratio. In some example embodiments, the DLL may include a set of cascaded, tunable, delay elements, a phase detector, a charge pump and a D-type flip-flop. In these embodiments, the delay elements may be configured to break a VCO period up into Nd equal packets of phase, where Nd is the number of delay elements in the delay line. In this way, the DLL provides negative feedback to help ensure that the total delay through the delay line is one VCO cycle.

In some embodiments, the synthesizer circuitry 928 may be configured to generate a carrier frequency as the output frequency, while in other embodiments, the output frequency may be a multiple of the carrier frequency (e.g., twice the carrier frequency, four times the carrier frequency) and used in conjunction with quadrature generator and divider circuitry to generate multiple signals at the carrier frequency with multiple different phases with respect to each other. In some embodiments, the output frequency may be a LO frequency (f_{LO}). In some embodiments, the RF circuitry 920 may include an IQ/polar converter.

The FEM circuitry 930 may include a receive signal path which may include circuitry configured to operate on RF signals received from one or more antennas 932, amplify the received signals and provide the amplified versions of the received signals to the RF circuitry 920 for further processing. The FEM circuitry 930 may also include a transmit signal path which may include circuitry configured to amplify signals for transmission provided by the RF circuitry 920 for transmission by one or more of the one or more antennas 932. In various embodiments, the amplification through the transmit or receive signal paths may be done solely in the RF circuitry 920, solely in the FEM circuitry 930, or in both the RF circuitry 920 and the FEM circuitry 930.

In some embodiments, the FEM circuitry 930 may include a TX/RX switch to switch between transmit mode and receive mode operation. The FEM circuitry 930 may include a receive signal path and a transmit signal path. The receive signal path of the FEM circuitry 930 may include an LNA to amplify received RF signals and provide the amplified received RF signals as an output (e.g., to the RF circuitry 920). The transmit signal path of the FEM circuitry 930 may include a power amplifier (PA) to amplify input RF signals (e.g., provided by the RF circuitry 920), and one or more filters to generate RF signals for subsequent transmission (e.g., by one or more of the one or more antennas 932).

In some embodiments, the PMC 934 may manage power provided to the baseband circuitry 904. In particular, the PMC 934 may control power-source selection, voltage scaling, battery charging, or DC-to-DC conversion. The PMC 934 may often be included when the device 900 is capable of being powered by a battery, for example, when the device 900 is included in an UE. The PMC 934 may increase the power conversion efficiency while providing desirable implementation size and beat dissipation characteristics.

FIG. 9 shows the PMC 934 coupled only with the baseband circuitry 904. However, in other embodiments, the PMC 934 may be additionally or alternatively coupled with, and perform similar power management operations for, other components such as, but not limited to, the application circuitry 902, the RF circuitry 920, or the FEM circuitry 930.

In some embodiments, the PMC 934 may control, or otherwise be part of, various power saving mechanisms of the device 900. For example, if the device 900 is in an RRC Connected state, where it is still connected to the RAN node as it expects to receive traffic shortly, then it may enter a state known as Discontinuous Reception Mode (DRX) after a period of inactivity. During this state, the device 900 may power down for brief intervals of time and thus save power.

If there is no data traffic activity for an extended period of time, then the device 900 may transition off to an RRC Idle state, where it disconnects from the network and does not perform operations such as channel quality feedback, handover, etc. The device 900 goes into a very low power state and it performs paging where again it periodically wakes up to listen to the network and then powers down again. The device 900 may not receive data in this state, and in order to receive data, it transitions back to an RRC Connected state.

An additional power saving mode may allow a device to be unavailable to the network for periods longer than a paging interval (ranging from seconds to a few hours). During this time, the device is totally unreachable to the network and may power down completely. Any data sent during this time incurs a large delay and it is assumed the delay is acceptable.

Processors of the application circuitry 902 and processors of the baseband circuitry 904 may be used to execute elements of one or more instances of a protocol stack. For example, processors of the baseband circuitry 904, alone or in combination, may be used to execute Layer 3, Layer 2, or Layer 1 functionality, while processors of the application circuitry 902 may utilize data (e.g., packet data) received from these layers and further execute Layer 4 functionality (e.g., transmission communication protocol (TCP) and user datagram protocol (UDP) layers). As referred to herein, Layer 3 may include a radio resource control (RRC) layer, described in further detail below. As referred to herein, Layer 2 may include a medium access control (MAC) layer, a radio link control (RLC) layer, and a packet data convergence protocol (PDCP) layer, described in further detail below. As referred to herein, Layer 1 may include a physical (PHY) layer of a UE/RAN node, described in further detail below.

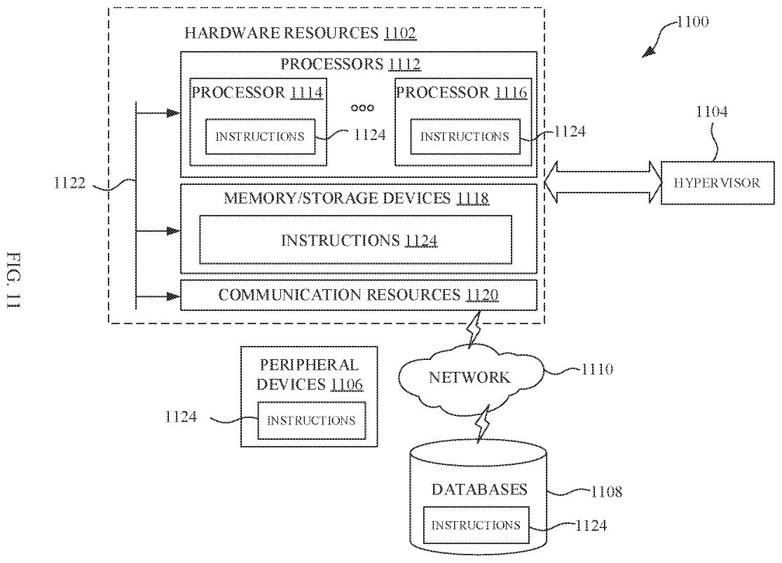

FIG. 10 illustrates example interfaces 1000 of baseband circuitry in accordance with some embodiments. As discussed above, the baseband circuitry 904 of FIG. 9 may include 3G baseband processor 906, 4G baseband processor 908, 5G baseband processor 910, other baseband processor(s) 912, CPU 914, and a memory 918 utilized by said processors. As illustrated, each of the processors may include a respective memory interface 1002 to send/receive data to/from the memory 918.

The baseband circuitry 904 may further include one or more interfaces to communicatively couple to other circuitries/devices, such as a memory interface 1004 (e.g., an interface to send/receive data to/from memory external to the baseband circuitry 904), an application circuitry interface 1006 (e.g., an interface to send/receive data to/from the application circuitry 902 of FIG. 9), an RF circuitry interface 1008 (e.g., an interface to send/receive data to/from RF circuitry 920 of FIG. 9), a wireless hardware connectivity interface 1010 (e.g., an interface to send/receive data to/from Near Field Communication (NFC) components, Bluetooth® components (e.g., Bluetooth® Low Energy), Wi-Fi® components, and other communication components), and a power management interface 1012 (e.g., an interface to send/receive power or control signals to/from the PMC 934.

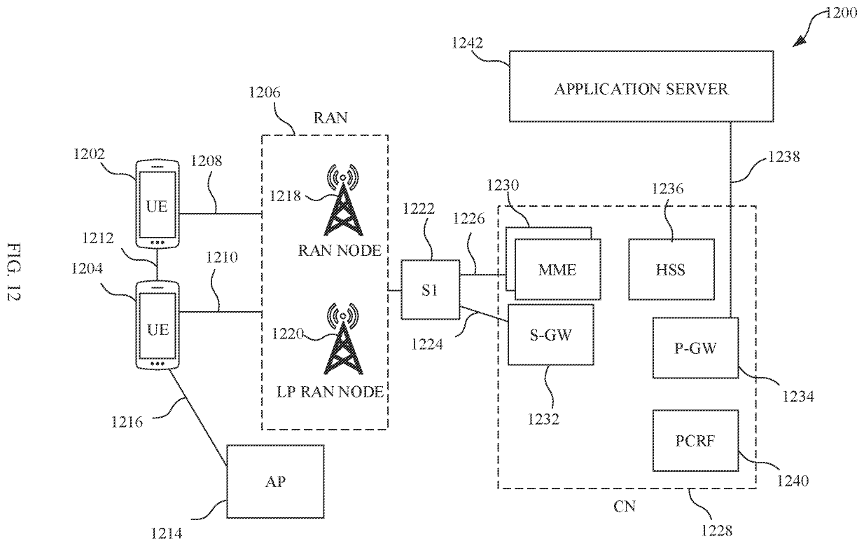

FIG. 11 is a block diagram illustrating components 1100, according to some example embodiments, able to read instructions from a machine-readable or computer-readable medium (e.g., a non-transitory machine-readable storage medium) and perform any one or more of the methodologies discussed herein. Specifically, FIG. 11 shows a diagrammatic representation of hardware resources 1102 including one or more processors 1112 (or processor cores), one or more memory/storage devices 1118, and one or more communication resources 1120, each of which may be communicatively coupled via a bus 1122. For embodiments where node virtualization (e.g., NFV) is utilized, a hypervisor 1104 may be executed to provide an execution environment for one or more network slices/sub-slices to utilize the hardware resources 1102.

The processors 1112 (e.g., a central processing unit (CPU), a reduced instruction set computing (RISC) processor, a complex instruction set computing (CISC) processor, a graphics processing unit (GPU), a digital signal processor (DSP) such as a baseband processor, an application specific integrated circuit (ASIC), a radio-frequency integrated circuit (RFIC), another processor, or any suitable combination thereof) may include, for example, a processor 1114 and a processor 1116.

The memory/storage devices 1118 may include main memory, disk storage, or any suitable combination thereof. The memory/storage devices 1118 may include, but are not limited to any type of volatile or non-volatile memory such as dynamic random access memory (DRAM), static random-access memory (SRAM), erasable programmable read-only memory (EPROM), electrically erasable programmable read-only memory (EEPROM), Flash memory, solid-state storage, etc.

The communication resources 1120 may include interconnection or network interface components or other suitable devices to communicate with one or more peripheral devices 1106 or one or more databases 1108 via a network 1110. For example, the communication resources 1120 may include wired communication components (e.g., for coupling via a Universal Serial Bus (USB)), cellular communication components, NFC components, Bluetooth® components (e.g., Bluetooth® Low Energy), Wi-Fi® components, and other communication components.

Instructions 1124 may include software, a program, an application, an applet, an app, or other executable code for causing at least any of the processors 1112 to perform any one or more of the methodologies discussed herein. The instructions 1124 may reside, completely or partially, within at least one of the processors 1112 (e.g., within the processor's cache memory), the memory/storage devices 1118, or any suitable combination thereof. Furthermore, any portion of the instructions 1124 may be transferred to the hardware resources 1102 from any combination of the peripheral devices 1106 of the databases 1108. Accordingly, the memory of the processors 1112, the memory/storage devices 1118, the peripheral devices 1106, and the databases 1108 are examples of computer-readable and machine-readable media.

For one or more embodiments, at least one of the components set forth in one or more of the preceding figures may be configured to perform one or more operations, techniques, processes, and/or methods as set forth in the example section below. For example, the baseband circuitry as described above in connection with one or more of the preceding figures may be configured to operate in accordance with one or more of the examples set forth below. For another example, circuitry associated with a UE, base station, network element, etc. as described above in connection with one or more of the preceding figures may be configured to operate in accordance with one or more of the examples set forth below in the example section.

FIG. 12 illustrates an architecture of a system 1200 of a network in accordance with some embodiments. The system 1200 includes one or more user equipment (UE), shown in this example as a UE 1202 and a UE 1204. The UE 1202 and the UE 1204 are illustrated as smartphones (e.g., handheld touchscreen mobile computing devices connectable to one or more cellular networks), but may also include any mobile or non-mobile computing device, such as Personal Data Assistants (PDAs), pagers, laptop computers, desktop computers, wireless handsets, or any computing device including a wireless communications interface.

In some embodiments, any of the UE 1202 and the UE 1204 can include an Internet of Things (IoT) UE, which can include a network access layer designed for low-power IoT applications utilizing short-lived UE connections. An IoT UE can utilize technologies such as machine-to-machine (M2M) or machine-type communications (MTC) for exchanging data with an MTC server or device via a public land mobile network (PLMN), Proximity-Based Service (ProSe) or device-to-device (D2D) communication, sensor networks, or IoT networks. The M2M or MTC exchange of data may be a machine-initiated exchange of data. An IoT network describes interconnecting IoT UEs, which may include uniquely identifiable embedded computing devices (within the Internet infrastructure), with short-lived connections. The IoT UEs may execute background applications (e.g., keep-alive messages, status updates, etc.) to facilitate the connections of the IoT network.

The UE 1202 and the UE 1204 may be configured to connect, e.g., communicatively couple, with a radio access network (RAN), shown as RAN 1206. The RAN 1206 may be, for example, an Evolved Universal Mobile Telecommunications System (E-UMTS) Terrestrial Radio Access Network (E-UTRAN), a NextGen RAN (NG RAN), or some other type of RAN. The UE 1202 and the UE 1204 utilize connection 1208 and connection 1210, respectively, each of which includes a physical communications interface or layer (discussed in further detail below); in this example, the connection 1208 and the connection 1210 are illustrated as an air interface to enable communicative coupling, and can be consistent with cellular communications protocols, such as a Global System for Mobile Communications (GSM) protocol, a code-division multiple access (CDMA) network protocol, a Push-to-Talk (PTT) protocol, a PTT over Cellular (POC) protocol, a Universal Mobile Telecommunications System (UMTS) protocol, a 3GPP Long Term Evolution (LTE) protocol, a fifth generation (5G) protocol, a New Radio (NR) protocol, and the like.

In this embodiment, the UE 1202 and the UE 1204 may further directly exchange communication data via a ProSe interface 1212. The ProSe interface 1212 may alternatively be referred to as a sidelink interface including one or more logical channels, including but not limited to a Physical Sidelink Control Channel (PSCCH), a Physical Sidelink Shared Channel (PSSCH), a Physical Sidelink Discovery Channel (PSDCH), and a Physical Sidelink Broadcast Channel (PSBCH).

The UE 1204 is shown to be configured to access an access point (AP), shown as AP 1214, via connection 1216. The connection 1216 can include a local wireless connection, such as a connection consistent with any IEEE 802.11 protocol, wherein the AP 1214 would include a wireless fidelity (WiFi®) router In this example, the AP 1214 may be connected to the Internet without connecting to the core network of the wireless system (described in further detail below).

The RAN 1206 can include one or more access nodes that enable the connection 1208 and the connection 1210. These access nodes (ANs) can be referred to as base stations (BSs), NodeBs, evolved NodeBs (eNBs), next Generation NodeBs (gNB), RAN nodes, and so forth, and can include ground stations (e.g., terrestrial access points) or satellite stations providing coverage within a geographic area (e.g., a cell). The RAN 1206 may include one or more RAN nodes for providing macrocells, e.g., macro RAN node 1218, and one or more RAN nodes for providing femtocells or picocells (e.g., cells having smaller coverage areas, smaller user capacity, or higher bandwidth compared to macrocells), e.g., a low power (LP) RAN node such as LP RAN node 1220.

Any of the macro RAN node 1218 and the LP RAN node 1220 can terminate the air interface protocol and can be the first point of contact for the UE 1202 and the UE 1204. In some embodiments, any of the macro RAN node 1218 and the LP RAN node 1220 can fulfill various logical functions for the RAN 1206 including, but not limited to, radio network controller (RNC) functions such as radio bearer management, uplink and downlink dynamic radio resource management and data packet scheduling, and mobility management.

In accordance with some embodiments, the UE 1202 and the UE 1204 can be configured to communicate using Orthogonal Frequency-Division Multiplexing (OFDM) communication signals with each other or with any of the macro RAN node 1218 and the LP RAN node 1220 over a multicarrier communication channel in accordance various communication techniques, such as, but not limited to, an Orthogonal Frequency-Division Multiple Access (OFDMA) communication technique (e.g., for downlink communications) or a Single Carrier Frequency Division Multiple Access (SC-FDMA) communication technique (e.g., for uplink and ProSe or sidelink communications), although the scope of the embodiments is not limited in this respect. The OFDM signals can include a plurality of orthogonal sub carriers.

In some embodiments, a downlink resource grid can be used for downlink transmissions from any of the macro RAN node 1218 and the LP RAN node 1220 to the UE 1202 and the UE 1204, while uplink transmissions can utilize similar techniques. The grid can be a time-frequency grid, called a resource grid or time-frequency resource grid, which is the physical resource in the downlink in each slot. Such a time-frequency plane representation is a common practice for OFDM systems, which makes it intuitive for radio resource allocation. Each column and each row of the resource grid corresponds to one OFDM symbol and one OFDM subcarrier, respectively. The duration of the resource grid in the time domain corresponds to one slot in a radio frame. The smallest time-frequency unit in a resource grid is denoted as a resource element. Each resource grid includes a number of resource blocks, which describe the mapping of certain physical channels to resource elements. Each resource block includes a collection of resource elements; in the frequency domain, this may represent the smallest quantity of resources that currently can be allocated. There are several different physical downlink channels that are conveyed using such resource blocks.

The physical downlink shared channel (PDSCH) may carry user data and higher-layer signaling to the UE 1202 and the UE 1204. The physical downlink control channel (PDCCH) may carry information about the transport format and resource allocations related to the PDSCH channel, among other things. It may also inform the UE 1202 and the UE 1204 about the transport format, resource allocation, and H-ARQ (Hybrid Automatic Repeat Request) information related to the uplink shared channel. Typically, downlink scheduling (assigning control and shared channel resource blocks to the UE 1204 within a cell) may be performed at any of the macro RAN node 1218 and the LP RAN node 1220 based on channel quality information fed back from any of the UE 1202 and UE 1204. The downlink resource assignment information may be sent on the PDCCH used for (e.g., assigned to) each of the UE 1202 and the UE 1204.

The PDCCH may use control channel elements (CCEs) to convey the control information. Before being mapped to resource elements, the PDCCH complex-valued symbols may first be organized into quadruplets, which may then be permuted using a sub-block interleaver for rate matching. Each PDCCH may be transmitted using one or more of these CCEs, where each CCE may correspond to nine sets of four physical resource elements known as resource element groups (REGs). Four Quadrature Phase Shift Keying (QPSK) symbols may be mapped to each REG. The PDCCH can be transmitted using one or more CCEs, depending on the size of the downlink control information (DCI) and the channel condition. There can be four or more different PDCCH formats defined in LTE with different numbers of CCEs (e.g., aggregation level, L=1, 2, 4, or 8).

Some embodiments may use concepts for resource allocation for control channel information that are an extension of the above-described concepts. For example, some embodiments may utilize an enhanced physical downlink control channel (EPDCCH) that uses PDSCH resources for control information transmission. The EPDCCH may be transmitted using one or more enhanced the control channel elements (ECCEs). Similar to above, each ECCE may correspond to nine sets of four physical resource elements known as enhanced resource element groups (EREGs). An ECCE may have other numbers of EREGs in some situations.

The RAN 1206 is communicatively coupled to a core network (CN), shown as CN 1228, via an S1 interface 1222. In embodiments, the CN 1228 may be an evolved packet core (EPC) network, a NextGen Packet Core (NPC) network, or some other type of CN. In this embodiment the S1 interface 1222 is split into two parts: the S1-U interface 1224, which carries traffic data between the macro RAN node 1218 and the LP RAN node 1220 and a serving gateway (S-GW), shown as S-GW 1232, and an S1-mobility management entity (MME) interface, shown as S1-MME interface 1226, which is a signaling interface between the macro RAN node 1218 and LP RAN node 1220 and the MME(s) 1230.

In this embodiment, the CN 1228 includes the MME(s) 1230, the S-GW 1232, a Packet Data Network (PDN) Gateway (P-GW) (shown as P-GW 1234), and a home subscriber server (HSS) (shown as HSS 1236). The MME(s) 1230 may be similar in function to the control plane of legacy Serving General Packet Radio Service (GPRS) Support Nodes (SGSN). The MME(s) 1230 may manage mobility aspects in access such as gateway selection and tracking area list management. The HSS 1236 may include a database for network users, including subscription-related information to support the network entities' handling of communication sessions. The CN 1228 may include one or several HSS 1236, depending on the number of mobile subscribers, on the capacity of the equipment, on the organization of the network, etc. For example, the HSS 1236 can provide support for routing/roaming, authentication, authorization, naming/addressing resolution, location dependencies, etc.

The S-GW 1232 may terminate the S1 interface 1222 towards the RAN 1206, and routes data packets between the RAN 1206 and the CN 1228. In addition, the S-GW 1232 may be a local mobility anchor point for inter-RAN node handovers and also may provide an anchor for inter-3GPP mobility. Other responsibilities may include lawful intercept, charging, and some policy enforcement.

The P-GW 1234 may terminate an SGi interface toward a PDN. The P-GW 1234 may route data packets between the CN 1228 (e.g., an EPC network) and external networks such as a network including the application server 1242 (alternatively referred to as application function (AF)) via an Internet Protocol (IP) interface (shown as IP communications interface 1238). Generally, an application server 1242 may be an element offering applications that use IP bearer resources with the core network (e.g., UMTS Packet Services (PS) domain, LTE PS data services, etc.). In this embodiment, the P-GW 1234 is shown to be communicatively coupled to an application server 1242 via an IP communications interface 1238. The application server 1242 can also be configured to support one or more communication services (e.g., Voice-over-Internet Protocol (VoIP) sessions, PTT sessions, group communication sessions, social networking services, etc.) for the UE 1202 and the UE 1204 via the CN 1228.

The P-GW 1234 may further be a node for policy enforcement and charging data collection. A Policy and Charging Enforcement Function (PCRF) (shown as PCRF 1240) is the policy and charging control element of the CN 1228. In a non-roaming scenario, there may be a single PCRF in the Home Public Land Mobile Network (HPLMN) associated with a UE's Internet Protocol Connectivity Access Network (IP-CAN) session. In a roaming scenario with local breakout of traffic, there may be two PCRFs associated with a UE's IP-CAN session: a Home PCRF (H-PCRF) within a HPLMN and a Visited PCRF (V-PCRF) within a Visited Public Land Mobile Network (VPLMN). The PCRF 1240 may be communicatively coupled to the application server 1242 via the P-GW 1234. The application server 1242 may signal the PCRF 1240 to indicate a new service flow and select the appropriate Quality of Service (QoS) and charging parameters. The PCRF 1240 may provision this rule into a Policy and Charging Enforcement Function (PCEF) (not shown) with the appropriate traffic flow template (TFT) and QoS class of identifier (QCI), which commences the QoS and charging as specified by the application server 1242.

### ADDITIONAL EXAMPLES

For one or more embodiments, at least one of the components set forth in one or more of the preceding figures may be configured to perform one or more operations, techniques, processes, and/or methods as set forth in the example section below. For example, the baseband circuitry as described above in connection with one or more of the preceding figures may be configured to operate in accordance with one or more of the examples set forth below. For another example, circuitry associated with a UE, base station, network element, etc. as described above in connection with one or more of the preceding figures may be configured to operate in accordance with one or more of the examples set forth below in the example section.

The following examples pertain to further embodiments.
Example 1 is a method for a user equipment (UE), comprising: receiving, from a base station (BS), at least one conditional handover (CHO) command that comprises an Ax event condition and a Tx event condition, wherein the Ax event condition includes A3, A4 or A5 event condition and the Tx event condition is a time-based trigger condition; evaluating both of the Ax event condition and the Tx event condition to determine whether either the Ax event condition or the Tx event condition is met; and determining, in response to determining either the Ax event condition or the Tx event condition is met, a triggered cell for executing a CHO.
Example 2 is the method of Example 1, wherein the Tx event condition comprises a T1 event condition including a T1 threshold and a first time duration using a universal time coordinated (UTC) time, and wherein the Tx event condition is met when a time measured at the UE becomes more than the T1 threshold but is less than a sum of the T1 threshold and the first time duration, wherein the UTC time is included in a radio resource control (RRC) message or acquirable from a system information block Type 9 (SIB9)
Example 3 is the method of Example 1, wherein the Tx event condition comprises a T2 event condition including a T2 threshold based on a source cell, and wherein the Tx event condition is met when a time measured at the UE becomes more than the T2 threshold.
Example 4 is the method of Example 3, wherein the T2 event condition further includes a second time duration configured based on one of a slot, a subframe and an absolute time, and wherein the Tx event condition is met when a time measured at the UE becomes more than the T2 threshold but is less than a sum of the T2 threshold and the second time duration.
Example 5 is the method of Example 3 or 4, wherein the T2 threshold is configured based on: a system frame number (SFN) index of the source cell and a slot index; the SEN index and a subframe index; the SFN index and an absolute time offset; a hyper SEN (H-SFN) index of the source cell, the SEN index and the slot index; the H-SFN index, the SEN index and the subframe index; or the H-SFN index, the SFN index and the absolute time offset.
Example 6 is the method of Example 1, wherein the Tx event condition comprises a T3 event condition including a timer with an expiration time which starts upon a reception time of the CHO command by the UE, wherein the expiration time is configured based on one of a slot, a subframe and an absolute time, and wherein the Tx event condition is met when a time measured at the UE becomes more than a sum of the reception time and the expiration time.
Example 7 is the method of Example 6, wherein the T3 event condition further includes a third time duration configured based on one of a slot, a subframe and an absolute time, and wherein the Tx event condition is met when a time measured at the UE becomes more than a sum of the reception time of the expiration time but is less than a sum of the reception time, the expiration time and the third time duration.
Example 8 is the method of any of Examples 1 to 7, wherein the determining, in response to determining cither the Ax event condition or the Ts event condition is met, the triggered cell for executing the CHO comprises: in response to determining the Ax event condition is met while the Tx event condition is not met, considering a candidate cell that meets the Ax event condition as the triggered cell.
Example 9 is the method of any of Examples 1 to 7, wherein the determining, in response to determining either the Ax event condition or the Ts event condition is met, the triggered cell for executing the CHO comprises: in response to determining the Tx event condition is met while the Ax event condition is not met, determining whether an additional Ax event condition with a network energy saving (NES) specific threshold included in the CHO command is met; and; in response to determining the additional Ax event condition is met, considering a candidate cell that meets the additional Ax event condition as the triggered cell.
Example 10 is the method of Example 9, wherein the additional Ax event condition is of the same type as the Ax event condition but with a different event threshold, or the additional Ax event condition is of a different type with the Ax event condition.
Example 11 is the method of any of Examples 1 to 7, wherein the determining, in response to determining either the Ax event condition or the Ts event condition is met, the triggered cell for executing the CHO comprises: in response to determining the Tx event condition is met the while the Ax event condition is not met, applying a threshold offset to the Ax event condition; determining whether the Ax event condition with the threshold offset is met; and in response to determining the Ax event condition with the threshold offset is met, considering a candidate cell that meets the Ax event condition with the threshold offset as the triggered cell.
Example 12 is the method of any of Examples 1 to 7, wherein the determining, in response to determining either the Ax event condition or the Ts event condition is met, the triggered cell for executing the CHO comprises: in response to determining the Tx event condition is met the while the Ax event condition is not met, determining whether a reference signal receiving power (RSRP) threshold or a reference signal receiving quality (RSRQ) threshold included in the CHO command is met; in response to determining the RSRP threshold or RSRQ threshold is met, considering a candidate cell that meets the RSRP threshold or RSRQ threshold as the triggered cell.
Example 13 is the method of Example 12, wherein the RSRP threshold or RSRQ threshold comprises an S criteria indicated in an SIB of the source cell or a new threshold included in the CHO command.
Example 14 is the method of any of Examples 1 to 13, wherein when a plurality of the triggered cells are existed, one of the plurality of the triggered cells is selected based on UE implementation.
Example 15 is the method of any of Examples 9 to 13, wherein whether the UE is to evaluate the additional Ax event condition, to apply the threshold offset to the Ax event condition or to determine the RSRP threshold or RSRQ threshold is indicated in the Tx event condition, the CHO command or a RRC message.
Example 16 is the method of Example 1, wherein in absence of the Tx event condition, the method comprises: in response to determining that the Ax event condition is met or an L1/L2 signaling from a source cell that is used to trigger the CHO execution is received, determining the triggered cell for executing the CHO, wherein the L1/L2 signaling is UE group common or cell common downlink control information (DCI)/medium access control-control element (MAC-CE).
Example 17 is the method of Example 1, wherein in absence of the Tx event condition, the method comprises: in response to determining that the Ax event condition is met or an indication, used to trigger the CHO execution, in a system information block (SIB) of a source cell is received, determining the triggered cell for executing the CHO.
Example 18 is the method of Example 16 or 17, the method further comprises: in response to determining the L1/L2 signaling or the indication in the SIB is received while the Ax event condition is not met: evaluating an additional Ax event condition with an NES specific threshold included in the CHO command to determine the triggered cell; applying a threshold offset to the Ax event condition to determine the triggered cell; or determining whether a RSRP threshold or a RSRQ threshold included in the CHO command is met to determine the triggered cell, wherein whether the UE is to evaluate the additional Ax event condition, to apply the threshold offset to the Ax event condition or to determine the RSRP threshold or RSRQ threshold is indicated in a RRC message for reception of the L1/L2 signaling, or is indicated in the indication in the L1/L2 signaling, or is indicated in the indication in the SIB for reception of the indication in the SIB.
Example 19 is an apparatus for a user equipment (UE), the apparatus comprising: one or more processors configured to perform steps of the method according to any of Examples 1-18.
Example 20 is a computer readable medium having computer programs stored thereon which, when executed by one or more processors, cause the one or more processors to perform steps of the method according to any of Examples 1-18.
Example 21 is a computer program product includes computer programs which, when executed by one or more processors, cause the one or more processors to perform steps of the method according to any of Examples 1-18.
Example 22 is an apparatus for a user equipment (UE), comprising means for performing steps of the method according to any of Examples 1-18.
Example 23 is a method for a base station (BS), comprising: configuring at least one conditional handover (CHO) command that comprises an Ax event condition and a Tx event condition, wherein the Ax event condition includes A3, A4 or A5 event condition and the Tx event condition is a time-based trigger condition; and providing the CHO command to a user equipment (UE) for determining whether either the Ax event condition or the Tx event condition is met
Example 24 is the method of Example 23, wherein the Tx event condition comprises one of: a T1 event condition including a T1 threshold and a first time duration using a universal time coordinated (UTC) time; a T2 event condition including a T2 threshold based on a source cell; a T2 event condition including a T2 threshold based on a source cell and a second time duration configured based on one of a slot, a subframe and an absolute time; a T3 event condition including a timer with an expiration time which starts upon a reception time of the CHO command by the UE; a T3 event condition including a timer with an expiration time which starts upon a reception time of the CHO command by the UE and a third time duration configured based on one of a slot, a subframe and an absolute time.
Example 25 is the method of Example 24, the method further comprising: providing a radio resource control (RRC) message including the UTC time to the UE.
Example 26 is an apparatus for a base station (BS), the apparatus comprising: one or more processors configured to perform steps of the method according to any of Examples 23-25.
Example 27 is a computer readable medium having computer programs stored thereon which, when executed by one or more processors, cause the one or more processors to perform steps of the method according to any of Examples 23-25.
Example 28 is a computer program product includes computer programs which, when executed by one or more processors, cause the one or more processors to perform steps of the method according to any of Examples 23-25.
Example 29 is an apparatus for a base station (BS), comprising means for performing steps of the method according to any of Examples 23-25.

Any of the above described examples may be combined with any other example (or combination of examples), unless explicitly stated otherwise. The foregoing description of one or more implementations provides illustration and description, but is not intended to be exhaustive or to limit the scope of embodiments to the precise form disclosed. Modifications and variations are possible in light of the above teachings or may be acquired from practice of various embodiments.

It should be recognized that the systems described herein include descriptions of specific embodiments. These embodiments can be combined into single systems, partially combined into other systems, split into multiple systems or divided or combined in other ways. In addition, it is contemplated that parameters/attributes/aspects/etc. of one embodiment can be used in another embodiment. The parameters/attributes/aspects/etc. are merely described in one or more embodiments for clarity, and it is recognized that the parameters/attributes/aspects/etc. can be combined with or substituted for parameters/attributes/etc. of another embodiment unless specifically disclaimed herein.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

Although the foregoing has been described in some detail for purposes of clarity, it will be apparent that certain changes and modifications may be made without departing from the principles thereof. It should be noted that there are many alternative ways of implementing both the processes and apparatuses described herein. Accordingly, the present embodiments are to be considered illustrative and not restrictive, and the description is not to be limited to the details given herein, but may be modified within the scope and equivalents of the appended claims.

1.-25. (canceled)

26. A method comprising:
receiving, from a base station (BS), at least one conditional handover (CHO) command that includes a first event condition that corresponds to an A3, A4, or A5 event condition;
receiving a layer 1 (L1) or layer 2 (L2) signal;
evaluating, based on receiving the L1 or L2 signal, the first event condition to determine that the first event condition is met; and
determining, based on evaluating the first event condition, a triggered cell for executing a CHO.

27. The method of claim 26, wherein determining the triggered cell for executing the CHO comprises:
in response to determining the first event condition is met, considering a candidate cell that meets the first event condition as the triggered cell.

28. The method of claim 26, wherein the first event condition includes a network energy saving (NES) specific threshold.

29. The method of claim 26, wherein the first event condition is a network energy saving (NES) condition and the at least one CHO command further comprises a second event condition that is not an NES condition, wherein the second event condition is of a same type as the first event condition but with a different event threshold, or the second event condition is of a different type than the first event condition.

30. The method of claim 26, further comprising:
receiving, in the CHO command or a radio resource control (RRC) message, an indication that evaluation of the first event condition is to be based on receiving the L1 or L2 signal.

31. The method of claim 26, wherein evaluating the first event condition includes a determination that the first event condition is met with respect to a candidate cell and said determining the triggered cell for executing the CHO comprises:
determining the candidate cell is the triggered cell.

32. The method of claim 26, wherein evaluating the first event condition includes a determination that the first event condition is not met and said determining the triggered cell for executing the CHO comprises:
in response to determining that the first event condition is not met, determining whether a reference signal receiving power (RSRP) threshold or a reference signal receiving quality (RSRQ) threshold included in the CHO command is met; and
in response to determining the RSRP threshold or RSRQ threshold is met, considering a candidate cell that meets the RSRP threshold or RSRQ threshold as the triggered cell.

33. The method of claim 26, wherein when a plurality of triggered cells exist, the method further comprises:
selecting one of the plurality of triggered cells for CHO execution.

34. An apparatus comprising:
interface circuitry; and
processing circuitry coupled with the interface circuitry, the processing circuitry to:
receive, from a base station (BS) via the interface circuitry, at least one conditional handover (CHO) command that comprises a first event condition that corresponds to an A3, A4, or A5 event condition;
receive a layer 1 (L1) or layer 2 (L2) signal;
evaluate, based on receipt of the L1 or L2 signal, the first event condition to determine that the first event condition is met; and
determine, based on evaluation of the first event condition, a triggered cell for executing a CHO.

35. The apparatus of claim 34, wherein to determine the triggered cell for executing the CHO, the processing circuitry is to:
in response to a determination that the first event condition is met for a candidate cell, determine that the candidate cell is the triggered cell.

36. The apparatus of claim 34, wherein the first event condition includes a network energy saving (NES) specific threshold.

37. The apparatus of claim 34, wherein the first event condition is a network energy saving (NES) condition and the at least one CHO command further comprises a second event condition that is not an NES condition, wherein the second event condition is of a same type as the first event condition but with a different event threshold, or the second event condition is of a different type than the first event condition.

38. The apparatus of claim 34, wherein to evaluate the first event condition includes a determination that the first event condition is not met and to determine the triggered cell for executing the CHO, the processing circuitry is to:
in response to a determination that the first event condition is not met, apply a threshold offset to the first event condition;
determine whether the first event condition with the threshold offset is met; and
in response to a determination that the first event condition with the threshold offset is met, consider a candidate cell that meets the first event condition with the threshold offset as the triggered cell.

39. The apparatus of claim 34, wherein to evaluate the first event condition includes a determination that the first event condition is not met and to determine the triggered cell for executing the CHO the processing circuitry is to:
in response to a determination that the first event condition is not met, determine whether a reference signal receiving power (RSRP) threshold or a reference signal receiving quality (RSRQ) threshold included in the CHO command is met; and
in response to a determination that the RSRP threshold or RSRQ threshold is met, consider a candidate cell that meets the RSRP threshold or RSRQ threshold as the triggered cell.

40. The apparatus of claim 34, wherein the processing circuitry is further to:
detect a plurality of triggered cells; and
select one of the plurality of the triggered cells for CHO execution.

41. The apparatus of claim 34, wherein the processing circuitry is further to:
receive the L1 or L2 signal from a source cell, wherein the L1 or L2 signal includes UE group common or cell common downlink control information (DCI).

42.-45. (canceled)

46. A method comprising:
generating, for transmission to a user equipment (UE), at least one conditional handover (CHO) command that includes a first event condition that corresponds to an A3, A4, or A5 event condition; and
generating, for transmission to the UE, a Layer 1 (L1) or Layer 2 (L2) signal to enable the UE to determine whether the first event condition is satisfied.

47. The method of claim 46, wherein the L1 or L2 signal comprises downlink control information.

48. The method of claim 46, wherein the first event condition is a network energy saving (NES) event condition.

49. The method of claim 48, wherein the at least one CHO command further includes a second event condition that is not an NES event condition.
